(19) United States
(12) Patent Application Publication
(10) Pub. No.: US 2009/0319926 A1
(43) Pub. Date: Dec. 24, 2009

(54) CALENDARING SYSTEM ABLE TO ASSIGN DELEGATES TO CALENDAR EVENTS OF AN ABSENT USER

(75) Inventors: AL CHAKRA, APEX, NC (US); SIMON P. O'DOHERTY, ARD-NA-GRIENE (IE); JOHN RICE, TRAMORE (IE); BENG KONG YAP, SANTRY (IE)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/141,901

(22) Filed: Jun. 18, 2008

(51) Int. Cl. G06F 3/048

(52) U.S. Cl. 715/764

(57) ABSTRACT

A time period can be detected for which a user associated with calendar system entries is to be absent. A set of the calendar system entries associated with the user and occurring during the time period can be detected. At least a portion of the identified calendar entries can be reassigned to at least one delegate. For each reassigned calendar entry, a corresponding calendar entry can be added to a calendar of the associated delegate.

### BACKGROUND OF THE INVENTION

The present invention relates to the field of collaborative calendaring systems and, more particularly, to a calendaring system able to assign delegates to calendar events of an absent user.

Calendaring systems maintain a number scheduled events to help users manage their time. Many calendaring systems are collaborative, which permits a sharing of calendar events, such as meetings, among a set of meeting participants. Most calendaring systems include user specific security settings, which prevents others from accessing a user's calendar. Often calendaring systems are integrated into a suite of communication tools and/or document management tools, which help coordinate data exchanges for meeting related activities.

One often experienced problem tangentially related to calendaring systems is unplanned absences. In a business context, for example, there will be times when an absence from the work environment is necessary. Sometimes this absence is in the form of sick leave, work-related leave, or vacation. When this occurs, employees are normally required to alert their manager, co-workers, and/or clients of the employee's absence. Absent employees are often tasked with informing their peers, supervisors, and other collaborators of meetings (typically scheduled in the employee's calendar of a calendaring system) and task items likely to be affected by the absence. Managers and peers then have the unenviable task of rescheduling meetings involving the absentee, of reallocating workload tasks with short suspense that the absentee was to handle, and of finding suitable meeting substitutes for the absentee.

Not only does this pose a problem for those (referred to herein as delegates) attempting to “cover” for an employee during their period of absence, but it also poses problems for the employee. A first problem experienced is that of determining which calendar events are affected by an absence. Sometimes an IT administrator can log onto an absent employees calendaring system using administrative privileges to determine this, but other times calendaring system security restrictions prevent others from accessing the employee's calendar. Next, determining an available set of delegates (based upon the delegates' schedules, skill set, and other factors) to handle the absentees tasks can be difficult, especially since little advanced warning often exists from notification of the absence to a time that a delegate is needed. Even assuming delegates are able to cover for an absentee, coordination with the absentee is needed so that the absentee knows results of the missed meetings or results of the delegate performed tasks. The absentee also must know which calendar entries were rescheduled, which weren't, and must adjust their calendars accordingly upon their return from the absence. Conventional calendaring systems lack tools for assisting with absentee situations.

### BRIEF DESCRIPTION OF THE SEVERAL VIEWS OF THE DRAWINGS

FIG. 1 is a schematic diagram illustrating a set of scenarios for a calendaring system that facilitates a handling of calendar events associated with an absent user for a period of absence in accordance with an embodiment of the inventive arrangements disclosed herein.

FIG. 2 is a schematic diagram illustrating a calendaring system having an absence manager component in accordance with an embodiment of the inventive arrangements disclosed herein.

FIG. 3 is a flowchart illustrating a method for automatically managing worker responsibilities in response to a worker absence event in accordance with an embodiment of the inventive arrangements disclosed herein.

FIG. 4 is a schematic diagram illustrating two calendar interfaces with absence management capabilities in accordance with an embodiment of the inventive arrangements disclosed herein.

### DETAILED DESCRIPTION OF THE INVENTION

The present invention discloses a calendaring system enhancement for handling absentee situations. The calendaring system can be notified when a calendar user is to be absent for a duration. Calendar events associated with the calendar user during this duration are then determined. One or more people (e.g., a supervisor of the absentee) can be notified of the calendar entries adversely affected by the absence. In one embodiment suitable delegates (other calendar users) can be automatically ascertained, where these delegates are people who are likely to be able to cover for the absentee for one or more of the calendar events. Different delegates can be ascertained for different calendar events based upon availability, skill set, and the like. The calendar system can help notify the delegates of their new responsibilities and can place events for which the delegates are to substitute for the absentee in the delegates' calendars. In one embodiment, delegation of calendar events is tentative until a delegate accepts the delegated event. The absentee's calendar can be automatically updated to reflect which delegates have handled which events. Further, results of events can be conveyed to the absentee, assuming the results were recorded by the delegate. The calendaring system can also facilitate the rescheduling of events, meetings, etc. when delegates to cover for an absence are not available.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

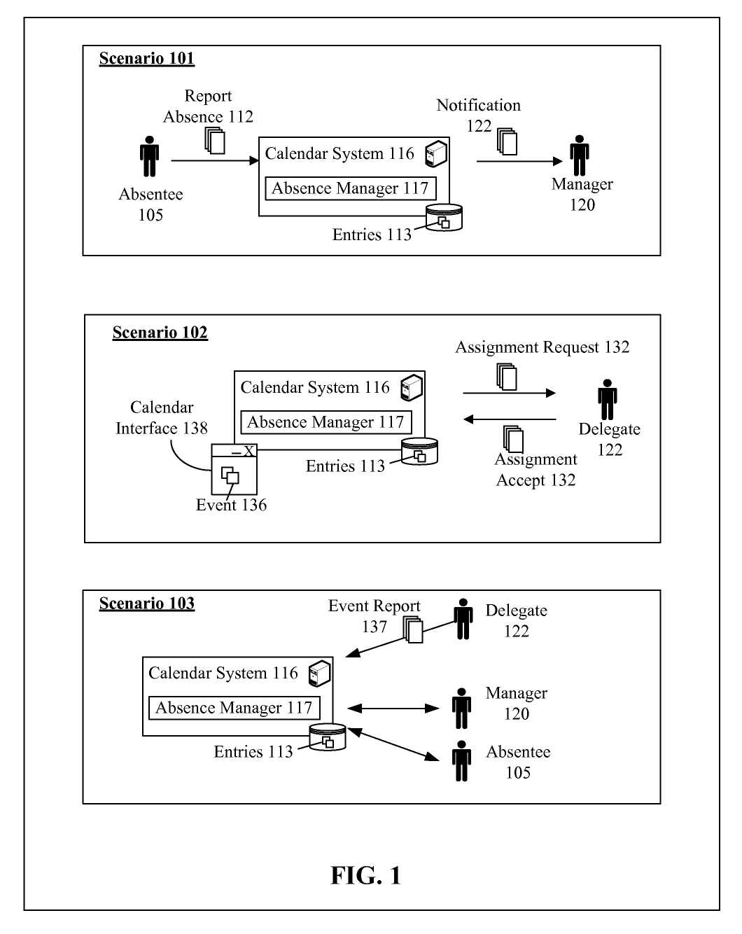

FIG. 1 is a schematic diagram illustrating a set of scenarios 101, 102 103 for a calendaring system that facilitates a handling of calendar entries associated with an absent user for a period of absence in accordance with an embodiment of the inventive arrangements disclosed herein.

Scenario 101 shows an absence reporting process. In scenario 101, an event can occur that causes a calendar system user (referred to as an absentee 105) to report an absence 112 for a period of time. The absentee 105 can directly report the absence 112 to calendar system 116 or an intermediary (e.g., a person who the absentee 105 reports their absence to, a person discovering the absence of absentee 105, etc.) can notify system 116 of the absence 112.

In the calendar system 116, receipt of the absence 112 can cause an absence manager component 117 to determine a set of calendar entries 113 affected by the absence 112. These calendar entries 113 can include those entries 113 occurring during the period of absence, as well as future calendar entries 113 that are unlikely to be completed in time due to the absence 112. Calendar entries 113 can include meeting entries, to-do entries, and other scheduled items associated with any event or task. In one embodiment, the absence manager 117 can automatically determine a set of delegates to handle one or more of the events 113 associated with the absentee, which are affected by the absence 112. The absence manager 117 can also reschedule one or more of the entries 113 in light of the absence 112.

Additionally, the absence manager 117 can optionally notify 122 a manager 120 of the affected events. This manager 120 can be presented with a list of potential delegates available to substitute for the absentee 105. In one embodiment, the manager 120 can select from among a set of situation handling options, such as rescheduling a calendar entry, designating a delegate, notifying a set of meeting attendees that an absentee 105 will not be attending the meeting, and other such actions. The managers 120 interaction with system 116 is optional to provide a human agent with control over steps/actions taken responsive to an absence. This human agent (manager 120) can normally lack permissions to access and/or manipulate the entries 113. Absence manager 117 can automatically escalate permissions granted to manager 120 for only those calendar entries 113 affected by the absence 112. In another embodiment, actions taken by calendar system 116 can be completely automated.

Scenario 102 illustrates that a set of delegates 122 can be notified when the calendar system 116 assigns responsibility for new calendar entries to these delegates 122 responsive to an absence 112 of another 105. In one embodiment, the assignments can initially be tentative, which require delegate 122 acceptance 132 after being prompted via a request 132. In another embodiment, the assignments 132 may not require acceptance 132, but are instead automatically added to a delegate's calendar. Newly assigned events 136 corresponding to an entry 113 for which a delegate 122 now has responsibility can be depicted in a characteristic fashion in a calendar interface 138 used by the delegate 122. For example, events 136 added to a delegate 122 calendar can be associated with a characteristic icon, background color, text label, and the like. In one embodiment, information associated with a newly added event 136 can be presented within the calendar interface 138. This information can include, for example, a list of event 136 attendees and contact information for each, electronic documents associated with the event 136, a context of events 136 or actions leading up to event 136, and other event 136 relevant information. Information provided with event 136 may include information, documents, etc. that delegate 122 normally lacks access to, yet which is made available to delegate 122 by absence manager 117 due to the event 136 assignment.

In scenario 103, the delegate 122 can submit an event report 137 to the calendaring system 116. This report 137 can include follow-on action items, event 136 minutes, a completion status indicator, and other event 136 specific data. When action items are contained in the report 137 these can be assigned to either the delegate 122 and/or the absentee 105, each of which can cause new entries 113 to be added to an associated user's calendar. The manager 120 and/or the absentee 105 can be informed that the delegate 122 has submitted the event report 137 and can be selectively granted access to report 137 content. The absence manager 117 can also update an absentee 105 calendar to reflect that the original entry 113 has been completed by proxy and can optionally annotate delegate 122 contact information to the entry 113, which can make follow-up actions easier for the absentee 105, who may have had many different delegates 122 perform actions to satisfy calendar entries 113 during a period of absence 112.

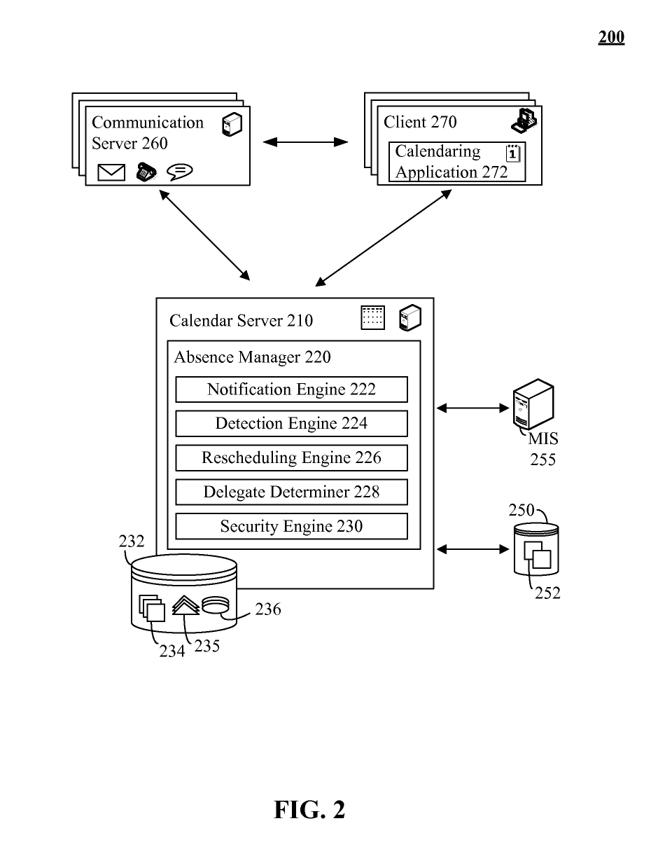

FIG. 2 is a schematic diagram illustrating a calendaring system 200 having an absence manager component 220 in accordance with an embodiment of the inventive arrangements disclosed herein. The calendaring system 200 can be one able to perform actions detailed in scenarios 101, 102, and 103.

In system 200, a calendaring server 210 can be communicatively linked to one or more client 270 computing devices. The clients 270 can include a calendaring application 272. Additionally, the clients 270 and calendaring system 210 can be communicatively linked to one or more communication server 260, such as an email server, instant messaging server, voice response server, and the like. The server 260 provides an means for the calendar server 210 to exchange information with client 270 or for clients 270 to exchange information to each other. Information can also be exchanged directly between the client 270 and the server 210 and/or directly between the clients 270 without being facilitated by server 260.

Although system 200 shows a client-server embodiment, other configurations are contemplated. For example, in one embodiment, the calendaring application 272 can be a standalone application executing upon a client 270. In one embodiment, functionality attributed to the absence manager 220 can be included in the stand-alone application 272. In another embodiment, functionality attributed to the absence manger 220 can be provided as a Web service that extends application 272 functionality. Additionally, in a client-server configuration, the calendaring server 210 can optionally be implemented as a cluster of servers and/or as a set of distributed computing elements, real or virtual, that together provide functionality discussed for server 210.

The absence manager 220 can be a component having access to calendar entries 234 of a data store 232. The absence manager 220 can perform a set of programmatic actions related to calendar entries 234 of an absentee to help parties involved cope with an absence situation. An absentee is a user associated with a set of calendar entries 234, who has been indicated as absentee for a period of time. One or more calendar entries 234 can exist that will be unsatisfied by the user (absentee) due to the absence. The absence manager 220 can include a notification engine 222, a detection engine 224, a rescheduling engine 226, a delegate determiner 228, a security engine 230, and/or the like.

The notification engine 222 is configured to receive absence notifications and/or to convey notifications regarding an absence. The absence notifications handled by the notification engine 222 can specify a user to be absent and a period of absence. In one embodiment, a user who is going to be absent can specify handling instructions for calendaring events when conveying the absence notification to the notification engine 222. For example, he/she can specify whether events occurring during the absence are to be rescheduled, assigned to a delegate for handling, and the like.

In one embodiment, a calendar user can establish a user specific profile 235 and settings 236 to be applied to programmatic actions related to absences. For example, the user profile 235 can specify a set of people who are “qualified” as delegates. These delegate preferences can be calendar entry specific, based upon a type of calendar entry (e.g., event type), and be for any other definable criteria associated with events. The settings 236 can establish preferences such as “reschedule events/meeting involving only local people”; “provide a delegate for non-local events”, “assign to-dos to a delegate when a user's schedule does not have available time slots for rescheduling,” etc. In one embodiment, a portion of the settings 236 configured for absence handling can be based upon company-level policies, supervisor established settings, and the like. User specification of absence handling parameters is optional and is not needed for all system 200 configurations.

Once an absence notification is conveyed to the notification engine 222, the detection engine 224 can determine a set of calendaring entries 234 affected by the absence. The detection engine 224 can include not only the calendar entries 234 during the period of absence, but can also include entries 234 affected by the absence. Calendar entries 234 determined by the detection engine 224 can be conveyed to others, as needed, by the notification engine 222. For example, the notification engine 222 can convey calendar entries 234 affected by an absence to a supervisor of the absentee.

The rescheduling engine 226 can automatically reschedule one or more calendaring entries 234 responsive to an absence. In one embodiment, the rescheduling engine 226 can prioritize entries 234 and can reschedule based upon their priority values. Priority values can be based upon any number of criteria, such as criteria established within a management information system 255 (i.e., different projects can have different importance values and calendar entries associated with relatively more important projects, different meeting participants can be considered more “valuable” than others, etc.). In one embodiment, the rescheduling engine 226 can reschedule not only an absentee's calendar entries, but can also reschedule calendar entries of other users responsive to an absence. For example, if a delegate covering for an absentee is to attend a meeting at 8:00 am-10:00 am, but has a to-do task scheduled to begin at 9:30, the to-do task list of the delegate can be rescheduled by engine 226 to make room for the meeting.

The delegate determiner 228 can be a component that determines a set of one or more people who are appropriate to choose to replace an absentee. This determination can be made based upon any of a number of factors, such as an availability of a replacement user (based upon their schedule as maintained within server 210), a skill set of the replacement user compared to those needed for scheduled event, a familiarity with the content of a given event/meeting/task, etc. In one embodiment, the delegate determiner 228 can be configured to make direct changes to calendar entries 234 of a set of users, including an absentee and one or more designees. In one embodiment, the delegate determiner 228 can be restricted to making tentative changes to user calendars, which must be confirmed/accepted by an affected user before being finalized.

The security engine 230 is a component that handles security considerations related to an absence. One role of the security engine 230 is to selectively grant access to calendar entries 234 to others (not the absentee), which may be contrary to default security settings. For example, a delegate (user assigned to a calendar entry 234 by delegator detector 228) may not typically have access to a calendar entry 234 and entry details of the absentee. The security engine 230 can redact information contained within calendar entries, such as confidential information about an absentee's personal impressions of a meeting or meeting participants. Further, personal calendar entries 234 entries related to family, friends, and the like can remain protected based upon security engine 230 settings. In one embodiment, the security engine 230 can selectively grant access to ancillary data and electronic files 252, shown as being stored in external data store 250, when assigning a delegate to handle a calendar entry 234. For example, a delegate may need to have contact information for meeting participants, which is usually unavailable due to security restrictions. In another example, a set of controlled electronic documents 252, a presentation slideshow, and/or other security controlled software artifacts can be situationally made available by the security engine 230 to a delegate.

The various components 210, 255, 252, 260, and 270 of system 200 can be communicatively linked to each other through one or more networks (not shown). The network can include any hardware/software/and firmware necessary to convey digital content encoded within carrier waves. Content can be contained within analog or digital signals and conveyed through data or voice channels and can be conveyed over a personal area network (PAN) or a wide area network (WAN). The network can include local components and data pathways necessary for communications to be exchanged among computing device components and between integrated device components and peripheral devices. The network can also include network equipment, such as routers, data lines, hubs, and intermediary servers which together form a packet-based network, such as the Internet or an intranet. The network can further include circuit-based communication components and mobile communication components, such as telephony switches, modems, cellular communication towers, and the like. The network can include line based and/or wireless communication pathways.

The various data stores of system 200, which include data stores 232 and 250 as well as data stores used by client 270 and server 260, can be physically implemented within any type of hardware including, but not limited to, a magnetic disk, an optical disk, a semiconductor memory, a digitally encoded plastic memory, a holographic memory, or any other recording medium. The data stores can be a stand-alone storage unit as well as a storage unit formed from a plurality of physical devices, which may be remotely located from one another. Additionally, information can be stored within each data store in a variety of manners. For example, information can be stored within a database structure or can be stored within one or more files of a file storage system, where each file may or may not be indexed for information searching purposes.

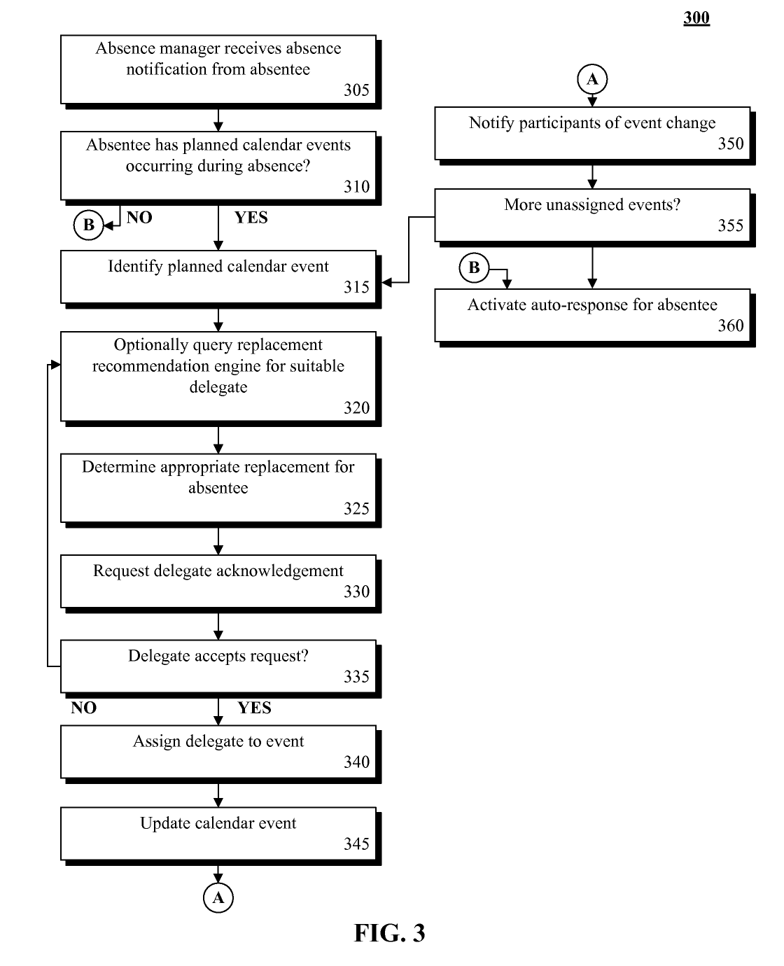

FIG. 3 is a flowchart illustrating a method 300 for automatically managing worker responsibilities in response to a worker absence event in accordance with an embodiment of the inventive arrangements disclosed herein. Method 300 can be performed in the context of system 200. In method 300, a worker can activate an absence manager to enable a designated delegate to perform scheduled activities on their behalf. The absence manager can be a component of a calendar system able to manage planned activities. Activities can include, but are not limited to, meetings, conferences, tasks, discussions, announcements, and the like.

In step 305, the absence manager receives absence notification from the absentee (e.g. an employee). Notification can include specification of the beginning of the absence period, termination of the absence period, delegate candidates, and the like. In step 310, if the absentee has planned calendar events occurring during the absence, the method can continue to step 315, else proceed to step 360. In step 315, a planned calendar event from the absentee is determined and selected. In step 320, the replacement recommendation engine can be queried for a suitable delegate if a delegate has not been specified. In step 325, an appropriate delegate can be determined based on results from recommendation engine and/or stored absentee preferences.

In step 330, a request for acknowledgement can be conveyed to the determined delegate. In step 335, if the delegate accepts the request, the method can continue to step 340, else return to step 320. In step 340, the delegate is assigned to the identified calendar event. In step 345, the calendar event can be updated to reflect the change. In step 350, the participants of the identified event can be notified of the change. In step 355, if there are more unassigned events the method can return to step 315, else continue to step 360. In step 360, an auto-respond component can be activated notify co-workers of the leave of absence.

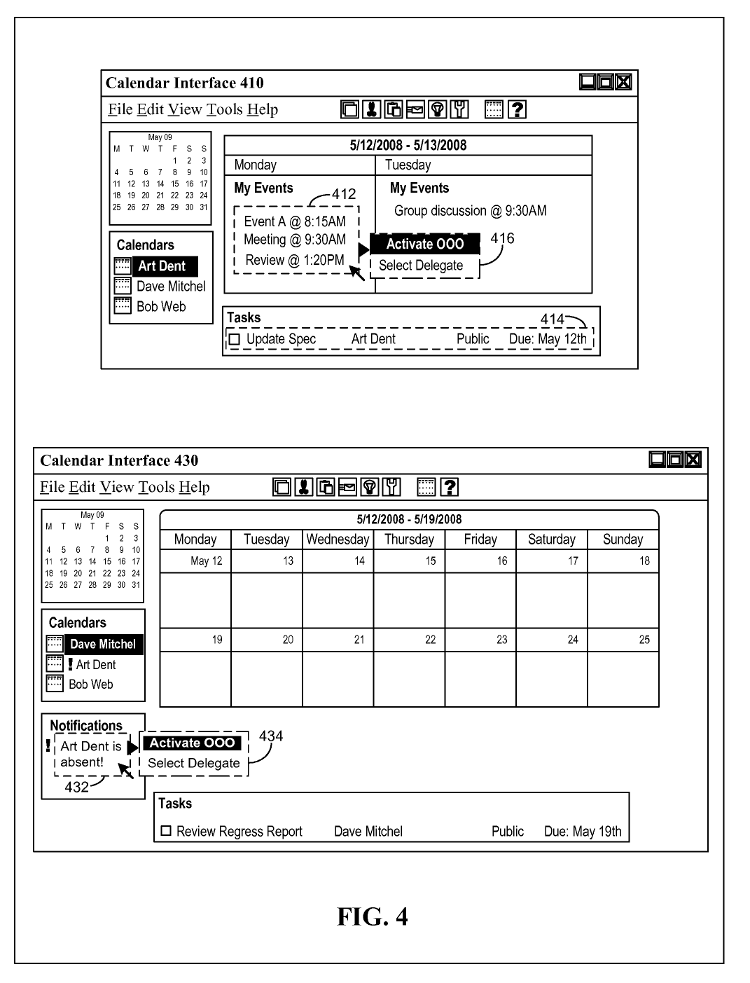

FIG. 4 is a schematic diagram illustrating two calendar interfaces 410, 430 with absence management capabilities in accordance with an embodiment of the inventive arrangements disclosed herein. Interface 410, 430 can be presented in the context of system 200. In calendar interface 410, planned events 412 and tasks 414 of an absentee can be handled by an absentee designated substitute (e.g., a delegate) during a period of absence. In calendar interface 430, a designated aide (e.g. manager) can act as a proxy and activate an absence manager for an absentee.

In one embodiment, interface 410 can permit an absentee to activate an absence manager for a period of time. During the specified period, activities such as events 412 and tasks 414 can be handled by a suitable delegate. Delegates can be chosen before or after the absence manager is activated. If no delegates are chosen, interface 410 can present absentee with a delegate selection interface.

Absence manager functionality can be accessed through a pull-down menu, context menu, popup dialog interface, and the like. For instance, context menu 416 can present an option to activate an out of office by proxy (e.g. absence manager) system for a set of events. Tasks 414 occurring during period of absence can be automatically added to the activities requiring attention from delegates.

Interface 430 can enable an absentee specified proxy to activate absence manager functionality on the absentee's behalf. In one embodiment, notification 432 can be automatically presented to the proxy during a period of absence of an absentee. Interface 430 can allow the proxy to activate an absence manager for the absentee. In addition, interface 430 can enable proxy to select one or more appropriate delegates if no delegates have been selected. In one instance, interface 430 present section 412 allowing a proxy to preview the calendar of the absentee.

The diagrams in FIGS. 1-4 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for handling calendar entries of an absent user comprising:
detecting a time period for which a user associated with calendar system entries is to be absent;
identifying a set of the calendar system entries occurring during the time period and associated with the user;
reassigning at least a portion of the identified calendar entries to at least one delegate; and
for each reassigned calendar entry, adding a corresponding calendar entry to a calendar of the associated delegate.

2. The method of claim 1, further comprising:
notifying a supervisor of the user of the identified calendar system entries;
prompting through a calendar system user interface the supervisor to designate a delegate to handle the identified calendar system entries;
receiving input via the calendar system user interface specifying which of the identified calendar entries are to be handled by a specified one of the at least one delegate; and
reassigning the identified calendar entries based upon the received input.

3. The method of claim 1, further comprising:
for each of the identified calendar entries, determining at least one person other than the user who possesses a skill set needed to handle the identified calendar entry;
querying calendar entries of each person possessing the skill set to determine availability at a time and place specified within the calendar entry; and
using query results identifying an available person with the skill set as the delegate.

4. The method of claim 1, further comprising:
tentatively assigning one of the calendar entries to the associated delegate;
conveying an electronic notification of the tentative assignment to the associated delegate;
receiving a response to the tentative assignment;
when the response indicates acceptance of the tentative assignment, changing a status of the assignment from tentative to concrete, wherein the reassigning is performed once the status of the assignment changes to concrete;
when the response indicates denial of the tentative assignment, determining a different delegate and tentatively assigning the calendar entry to the different delegate;
repeating the conveying, receiving, and determining steps for different delegates until the tentative assignment is accepted.

5. The method of claim 1, wherein the reassigned portion of the calendar system entries comprises meetings and to-do items.

6. The method of claim 1, further comprising:
conveying an electronic notification to the absent user regarding the reassignment.

7. The method of claim 1, further comprising:
determining a set of at least one electronic document associated with at least one reassigned calendar entry;
conveying the determined set to the delegate to whom the calendar entry has been reassigned.

8. The method of claim 1, further comprising:
after the reassigning of the portion of calendar entries occurs, receiving an update regarding the user that indicates the user will be available for the time period; and
revoking the reassignments of the calendar entries so that each is again associated with the user.

9. A computer program product for handling calendar entries of an absent user comprising:
a computer usable medium having computer usable program code embodied therewith, the computer usable program code comprising:
computer usable program code configured to detect a time period for which a user associated with calendar system entries is to be absent;
computer usable program code configured to identify a set of the calendar system entries occurring during the time period and associated with the user;
computer usable program code configured to reassign at least a portion of the identified calendar entries to at least one delegate; and
computer usable program code configured to, for each reassigned calendar entry, add a corresponding calendar entry to a calendar of the associated delegate.

10. The computer program product of claim 9, further comprising:
computer usable program code configured to notify a supervisor of the user of the identified calendar system entries;
computer usable program code configured to prompt through a calendar system user interface the supervisor to designate a delegate to handle the identified calendar system entries;
computer usable program code configured to receive input via the calendar system user interface specifying which of the identified calendar entries are to be handled by a specified one of the at least one delegate; and
computer usable program code configured to reassign the identified calendar entries based upon the received input.

11. The computer program product of claim 9, further comprising:
computer usable program code configured to, for each of the identified calendar entries, determine at least one person other than the user who possesses a skill set needed to handle the identified calendar entry;
computer usable program code configured to query calendar entries of each person possessing the skill set to determine availability at a time and place specified within the calendar entry; and
computer usable program code configured to use query results identifying an available person with the skill set as the delegate.

12. The computer program product of claim 9, further comprising:
computer usable program code configured to tentatively assign one of the calendar entries to the associated delegate;
computer usable program code configured to convey an electronic notification of the tentative assignment to the associated delegate;
computer usable program code configured to receive a response to the tentative assignment;
computer usable program code configured to change a status of the assignment from tentative to concrete when the response indicates acceptance of the tentative assignment, wherein the reassigning is performed once the status of the assignment changes to concrete;
computer usable program code configured to determine a different delegate and to tentatively assign the calendar entry to the different delegate when the response indicates denial of the tentative assignment, determine;
computer usable program code configured to repeat the conveying, receiving, and determining steps for different delegates until the tentative assignment is accepted.

13. The computer program product of claim 9, wherein the reassigned portion of the calendar system entries comprises meetings and to-do items.

14. The computer program product of claim 9, further comprising:
conveying an electronic notification to the absent user regarding the reassignment.

15. The computer program product of claim 9, further comprising:
computer usable program code configured to determine a set of at least one electronic document associated with at least one reassigned calendar entry;
computer usable program code configured to convey the determined set to the delegate to whom the calendar entry has been reassigned.

16. The computer program product of claim 9, further comprising:
computer usable program code configured to receive an update regarding the user that indicates the user will be available for the time period after the reassigning of the portion of calendar entries occurs; and
computer usable program code configured to revoke the reassignments of the calendar entries so that each is again associated with the user.

17. A system for managing calendar entries comprising:
An absence manager configured to receive notifications regarding an absence, to determine a set of calendar entries associated with a calendar user affected by the absence, and to take at least one programmatic action related to the determined set of calendar entries, wherein the at least one programmatic action comprises at least one of: notifying a supervisor of the determined calendar events affected by the absence, assigning delegates to handle the to one or more of the determined calendar events, and rescheduling calendaring entries affected by the absence.

18. The system of claim 17, wherein the absence manager is configured to selectively perform each of the programmatic actions depending upon situation specific factors.

19. The system of claim 17, wherein the absence manager is configured to automatically assign at least one delegate to handle at least one of the calendar entries; to convey a notification to the delegate about the calendar entry being assigned that requires a response that indicates whether the delegate accepts responsibility for calendar entry; and to add the calendar entry to a calendar of the delegate only when the delegates accepts the responsibility.
